(19) United States
(12) Patent Application Publication
(10) Pub. No.: US 2026/0333168 A1
(43) Pub. Date: Oct. 22, 2026

(54) PDU TRANSFER IN AN INTER-AMF HANDOVER WITHOUT INTER AMF INTERFACE

(71) Applicant: QUALCOMM Incorporated, San Diego, CA (US)

(72) Inventors: Kuo-Chun LEE, San Diego, CA (US); Arvind Vardarajan SANTHANAM, San Diego, CA (US); Haris ZISIMOPOULOS, London (GB); Abhishek BHATNAGAR, San Diego, CA (US); Osama LOTFALLAH, San Diego, CA (US)

(21) Appl. No.: 19/115,072

(22) PCT Filed: Oct. 11, 2023
(86) PCT No.: PCT/US2023/034921

§ 371 Date: Mar. 25, 2025

(30) Foreign Application Priority Data
Dec. 8, 2022 (GR) 20220101016

(51) Int. Cl. H04W 36/14; H04W 60/00; H04W 64/00

(52) U.S. Cl. CPC H04W 36/142; H04W 60/00; H04W 64/00

(57) ABSTRACT

Method and apparatus for optimizing inter-AMF mobility. The apparatus initiates a connection setup with a second network to initiate a network change from a first network to the second network. The apparatus transmits, to the second network, a registration request comprising a mobility registration indication in response to an initiation of the network change. The apparatus transmits, to the second network, an identity indication in response to an identity request from the second network in response to the registration request. The apparatus receives, from the second network, a registration acceptance indication in response to transmission of the identity indication. The apparatus transmits, to the second network, a PDU session establishment request indicating an existing PDU session from the first network for use on the second network.

### CROSS-REFERENCE TO RELATED APPLICATION

This application claims the benefit of Greece Patent Application Serial No. 20220101016, entitled “OPTIMIZATION OF INTER-ACCESS AND MOBILITY MANAGEMENT FUNCTION MOBILITY” and filed on Dec. 8, 2022, which is expressly incorporated by reference herein in its entirety.

### TECHNICAL FIELD

The present disclosure relates generally to communication systems, and more particularly, to a configuration for optimization of inter-access and mobility management function (AMF) mobility.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus initiates a connection setup with a second network to initiate a network change from a first network to the second network. The apparatus transmits, to the second network, a registration request comprising a mobility registration indication in response to an initiation of the network change. The apparatus transmits, to the second network, an identity indication in response to an identity request from the second network in response to the registration request. The apparatus receives, from the second network, a registration acceptance indication in response to transmission of the identity indication. The apparatus transmitting, to the second network, a packet data unit (PDU) session establishment request indicating an existing PDU session from the first network for use on the second network.

In an aspect of the disclosure, a method, a computer-readable medium, and an apparatus are provided. The apparatus may be a device at a network entity. The device may be a processor and/or a modem at a network entity or the network entity itself. The apparatus obtains a request to initiate a connection setup with a user equipment (UE) to initiate a network change from a first network to a second network, wherein the network entity is associated with the second network. The apparatus obtains, from the UE, a registration request comprising a mobility registration indication in response to an initiation of the network change. The apparatus obtains, from the UE, an identity indication in response to an identity request provided to the UE in response to the registration request. The apparatus provides, to the UE, a registration acceptance indication in response to transmission of the identity indication. The apparatus obtains, from the UE, a packet data unit (PDU) session establishment request indicating an existing PDU session from the first network for use on the second network.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example of networks where an inter-AMF interface (N14) is deployed.

FIG. 4B is a diagram illustrating an example of networks where an inter-AMF interface (N14) is not deployed.

FIG. 5 is a diagram illustrating an example of a call flow where an inter-AMF interface is not deployed.

FIG. 6 is a diagram illustrating an example of a call flow where an inter-AMF interface is deployed, in accordance with aspects of the disclosure.

FIG. 7 is a diagram illustrating an example of a GUTI.

FIG. 8 is a diagram illustrating an example of a call flow where an inter-AMF interface is deployed, in accordance with aspects of the disclosure.

FIG. 9 is a call flow diagram of signaling between and UE and a network entity.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a flowchart of a method of wireless communication.

FIG. 14 is a flowchart of a method of wireless communication.

FIG. 15 is a diagram illustrating an example of a hardware implementation for an example network entity.

### DETAILED DESCRIPTION

In wireless communication systems, such as in millimeter wave (mmW) stand-alone systems, different networks operating in different frequency ranges (e.g., FR1, FR2) may utilize hardware from different vendors. In instances where different networks operating in different frequency ranges are using hardware from different vendors, it is likely that the inter-AMF interface (e.g., N14) is not deployed. Without the deployment of the inter-AMF interface, seamless mobility may not be possible. For example, the UE may not be able to use handover and may only use redirection when switching from a first network to a second network. In an effort to overcome such instances, a UE may provide an identity indication to the second network while switching from the first network to the second network. The identity indication may allow the second network to identify the UE to allow for an existing PDU session utilized on the first network to be utilized on the second network.

Various aspects relate generally to optimization of inter-AMF mobility. Some aspects more specifically relate to a configuration to allow for inter-AMF interface to be supported in instances where hardware from different vendors is used for at least the AMF between different networks. In some examples, a UE may provide identification information related to the UE to allow an existing PDU session, utilized on an existing network, to be established on a new network. For example, a UE may be connected to a first network and may initiate a network change to a second network, such that the existing PDU session from the first network may be utilized by the UE on the second network.

At least one advantage of the disclosure is that a UE switching from a first network to a second network may utilize an existing PDU session, utilized on the first network, on the second network upon switching onto the second network. Using the existing PDU session on the second, or newly connected network, may allow the UE to maintain services that utilized the existing PDU session and not experience any service interruptions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure.

One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein.

In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

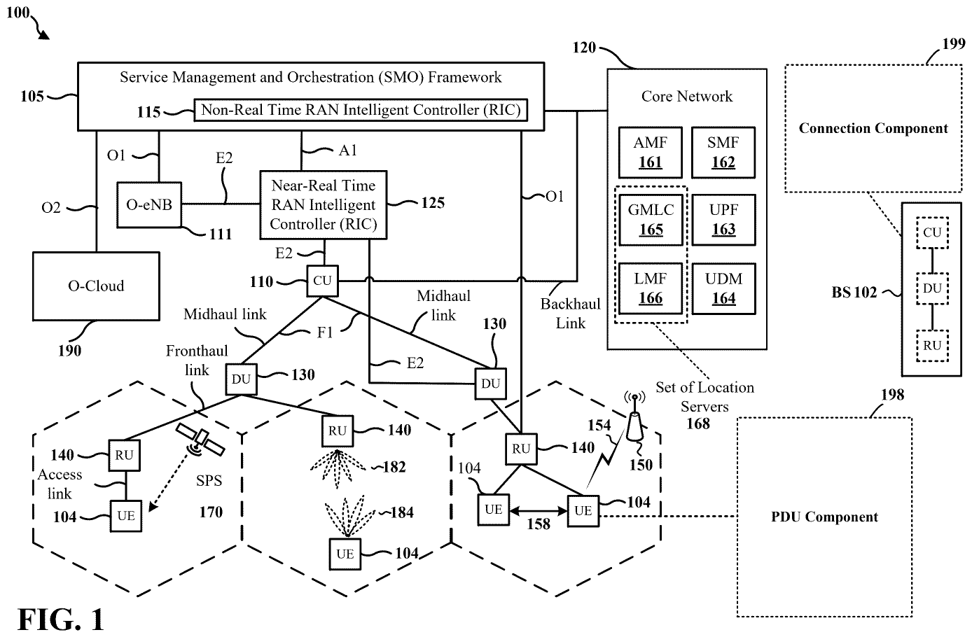

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may comprise a PDU component 198 configured to initiate a connection setup with a second network to initiate a network change from a first network to the second network; transmit, to the second network, a registration request comprising a mobility registration indication in response to an initiation of the network change; transmit, to the second network, an identity indication in response to an identity request from the second network in response to the registration request; receive, from the second network, a registration acceptance indication in response to transmission of the identity indication; and transmit, to the second network, a PDU session establishment request indicating an existing PDU session from the first network for use on the second network.

Referring again to FIG. 1, in certain aspects, the base station 102 may comprise a connection component 199 configured to obtain a request to initiate a connection setup with a UE to initiate a network change from a first network to a second network, wherein the network entity is associated with the second network; obtain, from the UE, a registration request comprising a mobility registration indication in response to an initiation of the network change; obtain, from the UE, an identity indication in response to an identity request provided to the UE in response to the registration request; provide, to the UE, a registration acceptance indication in response to transmission of the identity indication; and obtain, from the UE, a PDU session establishment request indicating an existing PDU session from the first network for use on the second network.

Although the following description may be focused on 5G NR, the concepts described herein may be applicable to other similar areas, such as LTE, LTE-A, CDMA, GSM, and other wireless technologies.

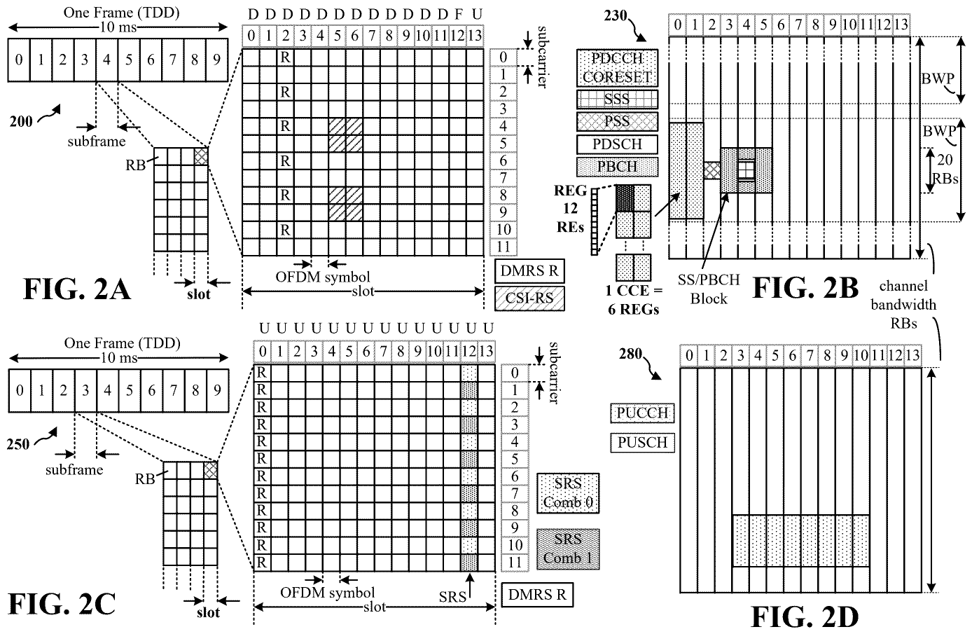

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 24*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

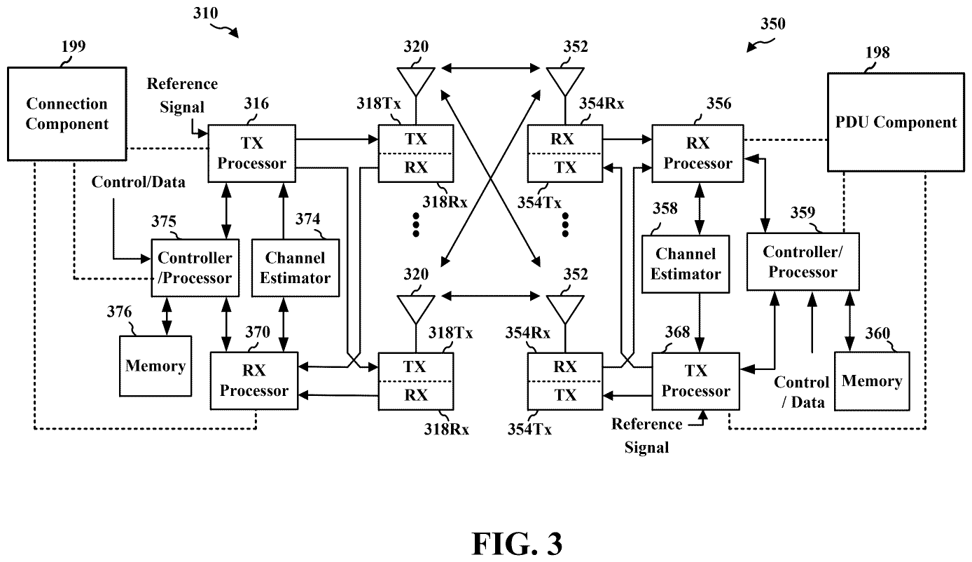

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the PDU component 198 of FIG. 1.

At least one of the TX processor 316, the RX processor 370, and the controller/processor 375 may be configured to perform aspects in connection with the connection component 199 of FIG. 1.

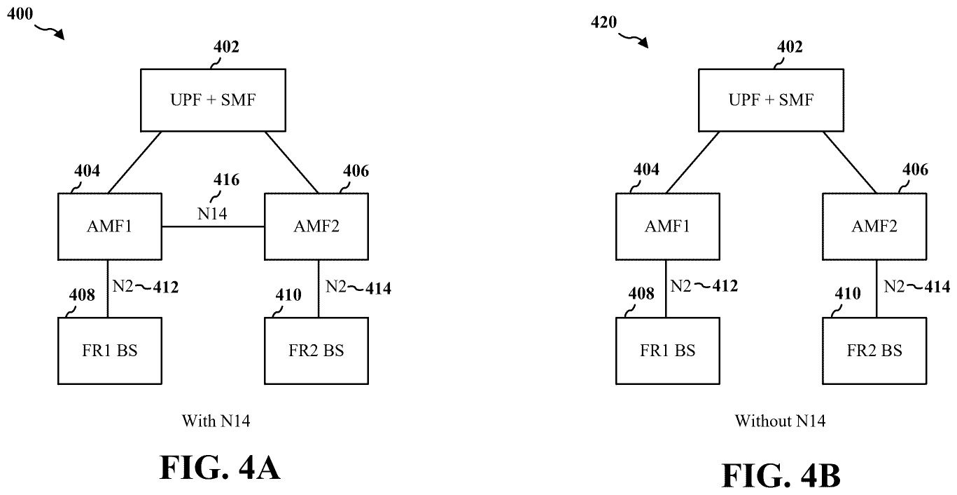

In wireless communication systems, such as in mmW stand-alone systems, different networks operating in different frequency ranges (e.g., FR1, FR2) may utilize hardware from different vendors. In instances where different networks operating in different frequency ranges are using hardware from different vendors, it is likely that the inter-AMF interface (e.g., N14) is not deployed. However, in instances where different networks operating in different frequency ranges are using hardware from the same vendor, then the inter-AMF interface (e.g., N14) may be deployed. With reference to diagram 400 of FIG. 4A, the diagram 400 includes a user plane function (UPF) and a session management function (SMF), where the UPF+SMF 402 may be configured to provide data processing for AMF1 404 or AMF2 406. Each of AMF1 and AMF2 have an interface N2 412, 414 to a respective base station (BS) 408, 410. The BS 408 may operate on FR1, while BS 410 may operate on FR2. The hardware components in diagram 400 may use the same vendor, such that inter-AMF interface (e.g., N14 416) is supported between AMF1 404 and AMF2 406. In some instances, the UPF+SMF 402 may be shared for both BS 408 and BS 410 because the UPF+SMF 402 may be from another vendor. However, with reference to diagram 420 of FIG. 4B, in instances where at least the hardware for the AMF (e.g., 404, 406) is from different vendors, then the inter-AMF interface may not be deployed. Without the deployment of the inter-AMF interface, seamless mobility may not be possible. For example, the UE may not be able to use handover and may only use redirection.

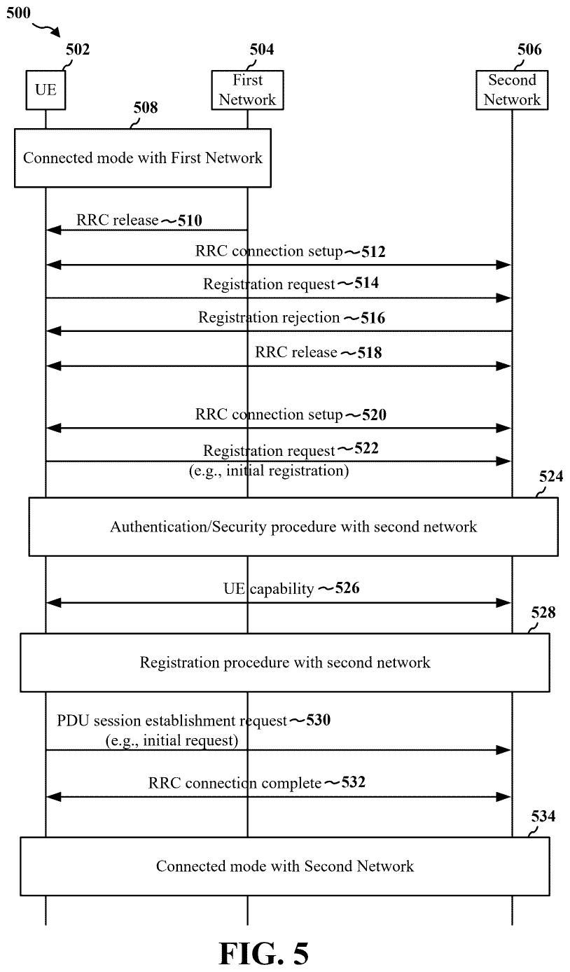

FIG. 5 is a diagram illustrating an example of a call flow where the inter-AMF interface is not deployed. The diagram 500 includes a UE 502, a first network 504, and a second network 506.

As indicated at 508, the UE 502 may be in a connected mode with the first network 504. The UE 502 may determine that it would like to switch from the first network 504 to the second network 506. The UE 502 may determine to switch to the second network for various reasons, such as but not limited to, coverage degradation from the first network or the second network providing better coverage than the first network. In such instances, the UE 502 may receive an RRC release 510 from the first network 504. The UE may then initiate a connection request with the second network by transmitting an RRC connection setup 512 to the second network 506. The UE may transmit a registration request 514 to the second network. However, the second network may response by transmitting a registration rejection 516 to the UE. The second network may reject the registration because the UE identity may not be derived by the second network. The second network may then transmit an RRC release 518 to the UE in response to the registration rejection 516.

The UE 502, at 520, may then re-initiate the RRC connection setup with the second network. The UE may transmit the registration request 522 to the second network. However, the registration request 522 is an initial registration request. At 524, an authentication and security procedure may be performed in response to the initial registration request. After the completion of the authentication and security procedure, the UE may provide a UE capability 526 to the second network. The UE may provide the UE capability 526 to the second network in response to a request for a UE capability from the second network.

At 528, the registration procedure may be performed between the UE and the second network. For example, the second network may provide a registration acceptance indication, and the UE may respond with a registration complete indication. Upon completion of the registration procedure, the UE may transmit a PDU session establishment request 530. The PDU session establishment request 530 is an initial request for a PDU session due to the UE connection request being rejected (e.g., registration rejection 516). The UE may receive an indication of acceptance to initiate a PDU session with the second network in response to the PDU session establishment request 530. The connection with the second network may be completed upon receipt of the RRC connection complete 532. The UE 502 may be connected with the second network and may be in a connected mode with the second network, as shown at 534.

Although the UE 502 is in a connected mode with the second network, the inter-AMF interface (e.g., N14) may not be deployed and the UE has to perform the initial registration and initial request of the PDU session establishment, which may delay mobility procedures. In addition, the IP address the UE had while connected to the first network may not be utilized upon the UE being in the connected mode with the second network. The UE receives a new IP address upon connection with the second network due in part to the PDU session establishment request being an initial request. The PDU session the UE had while on the first network may not be available to the UE upon transitioning to the second network due to the lack of deployment of the inter-AMF interface (e.g., N14). As such, the UE is assigned a new IP address and the change of the IP address may substantially impact voice call (e.g., voice over NR) and cause the voice call to drop.

Aspects presented herein provide a configuration to allow for inter-AMF interface to be supported in instances where hardware from different vendors is used for at least the AMF between different networks. At least one advantage of the disclosure is that a UE switching from a first network to a second network may utilize an existing PDU session, utilized on the first network, on the second network upon switching onto the second network. Using the existing PDU session on the second, or newly connected network, may allow the UE to maintain services that utilized the existing PDU session and not experience any service interruptions.

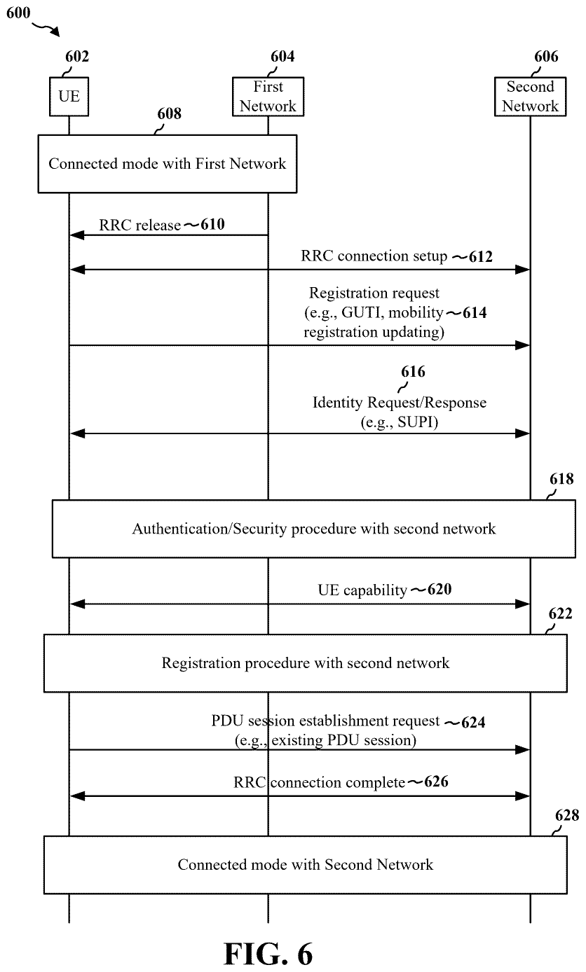

FIG. 6 is a diagram illustrating an example of a call flow where an inter-AMF interface is deployed. The diagram 600 includes a UE 602, a first network 604, and a second network 606.

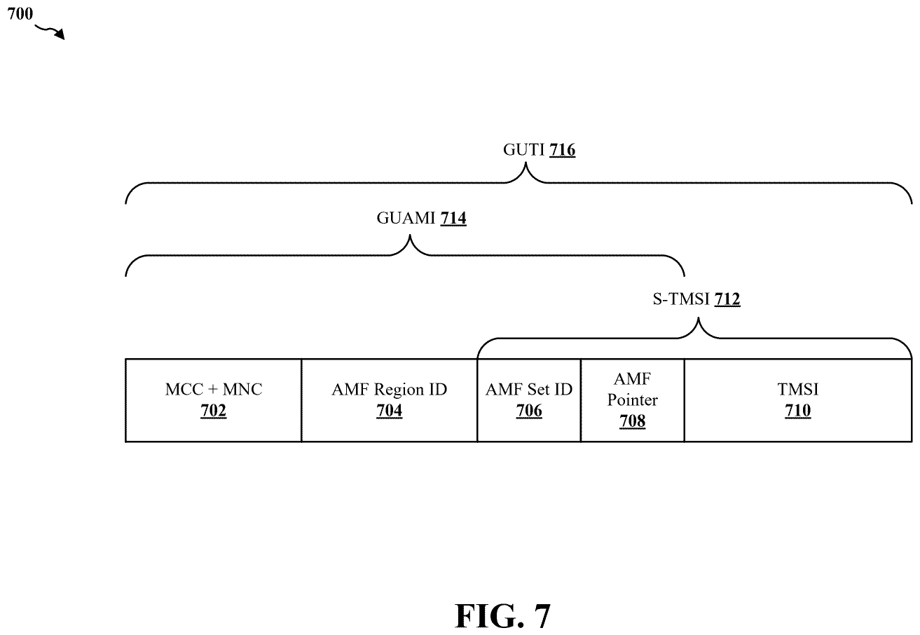

As indicated at 608, the UE 602 may be in a connected mode with the first network 604. The UE 602 may determine that it would like to switch from the first network 604 to the second network 606. The UE 602 may determine to switch to the second network for various reasons, for example, as discussed above. The UE 602 may receive an RRC release 610 from the first network 604, in response to initiating a switch to the second network 606. The UE may then initiate a connection request with the second network by transmitting an RRC connection setup 612 to the second network 606. The UE may also transmit a registration request 614 to the second network. The registration request 614 may comprise a global unique temporary identifier (GUTI), as well as mobility registration updating. With reference to diagram 700 of FIG. 7, the GUTI 716 may comprise a mobile country code (MCC) and a mobile network code (MNC) 702, an AMF region identifier (ID) 704, an AMF set ID 706, an AMF pointer 708, and/or a temporary mobile subscriber identity (TMSI) 710. The GUTI 716 may comprise an S-TMSI 712, where the S-TMSI may comprise the AMF set ID 706, the AMF pointer 708, and the TMSI 710. The GUTI 716 may comprise a global unique AMF ID (GUAMI) 714. The GUAMI 714 may comprise at least the MCC and MNC 702, the AMF region ID 704, the AMF set ID 706, and/or the AMF pointer 708.

An AMF associated with the second network 606 may receive the registration request 614 comprising the GUTI, but the AMF associated with the second network 606 may not be able to locate the UE 602 based on the GUTI within the registration request 614. Instead of rejecting the registration request, the second network, at 616, may provide the UE with an identity request, and the UE may respond with a subscription permanent identifier (SUPI) of the UE. The second network may utilize the SUPI of the UE to verify the identity of the UE. For example, the second network may provide the SUPI of the UE to a user data management (UDM) or home subscriber service (HSS) to verify the SUPI of the UE. In addition, the AMF associated with the second network 606 may utilize the GUAMI of the GUTI that is related to the AMF associated with the first network to assist in the identification of the UE 602. For example, the second network may request an international mobile subscriber identity (IMSI) or a subscription concealed identifier (SUCI) of the UE to identify the UE. The AMF associated with the second network may utilize the SUPI, SUCI, or IMSI of the UE to identify any existing PDU sessions with the UPF and/or SMF.

Authentication and security procedures with the second network may be completed, at 618. For example, the AMF associated with the second network may authenticate the UE 602 on the second network. Upon the completion of the authentication and security procedures with the second network, the AMF associated with the second network may register the UE with the UPF and SMF and the UDM, such that the UE may be deregistered with the AMF associated with the first network. For example, the AMF associated with the second network may inform the UDM that the UE 602 has joined the AMF associated with the second network, such that the AMF associated with the first network is informed that the UE 602 has joined a new AMF and is released from the AMF associated with the first network.

At 620, the UE may provide the second network with an indication of UE capability 620. The UE capability 620 may indicate to the second network that the UE supports an existing PDU session establishment procedure.

At 622, registration procedures with the second network may occur. For example, the second network may provide the UE with a registration acceptance indication, and the UE may respond with a registration complete indication.

At 624, the UE may transmit a PDU session establishment request 624. The PDU session establishment request 624 may comprise a request for an existing PDU session. For example, the UE may request the second network to utilize the existing PDU session that the UE used while on the first network. The AMF associated with the second network may forward the PDU session establishment request to the UPF and SMF to utilize the existing PDU session on the second network. Since the identity of the UE 602 has been previously determined, during at least the authentication and security procedure 618, the existing PDU session request may be granted, such that the UE 602 may utilize the existing PDU session, that the UE utilized on the first network, on the second network. As such, the UE 602 may continue to use the IP address, which was used on the first network, on the second network without interruption to services due to the switch from the first network to the second network.

At 626, the RRC connection procedure may be completed. For example, the second network may provide the UE with an RRC reconfiguration, and the UE may response by transmitting an RRC reconfiguration complete indication.

At 628, the UE 602 is in a connected mode with the second network 606. The UE 802 may communicate with the second network using the existing PDU session.

In the aspect of FIG. 6, the UE and second network may need to know of each other to enable the PDU session establishment request to use the existing PDU session on the second network. The UE may know that switching to a different network using a different frequency range may trigger the use of the existing PDU session establishment instead of requesting an initial PDU session establishment. The UE may know that the network may be capable of the existing PDU session establishment procedure based on the authentication and security procedure in mobility registration followed by the registration acceptance indication including a PDU session status information element with all PDU sessions set to inactive. The network may assume that the UE is capable of the existing PDU session establishment procedure based on the last registered tracking area identity (TAI) sent in the registration request. The network may know that the UE supports existing PDU session establishment procedure based on the UE indicating a capability of supporting interworking without N26 in the registration request. Support of interworking without N26 capability may be an implicit indication that the UE supports the existing PDU session establishment procedure. The UE may know that the network supports the existing PDU session establishment procedure by the network indicating support for interworking without N26.

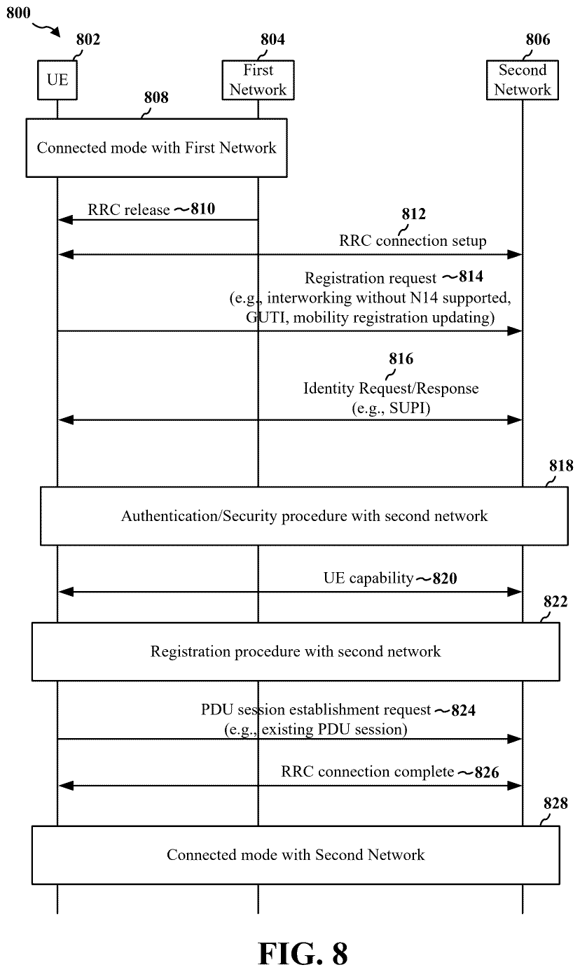

FIG. 8 is a diagram illustrating an example of a call flow where an inter-AMF interface is deployed. The diagram 800 includes a UE 802, a first network 804, and a second network 806. Many of the steps/procedures of the diagram 800 of FIG. 8 may be the same or similar to those of diagram 600 of FIG. 6, such that duplicative descriptions may not be included.

As indicated at 808, the UE 802 may be in a connected mode with the first network 804. The UE 802 may determine that it would like to switch from the first network 804 to the second network 806. The UE 802 may determine to switch to the second network for various reasons, for example, as discussed above. The UE 802 may receive an RRC release 810 from the first network 804, in response to initiating a switch to the second network 806. The UE may then initiate a connection request with the second network by transmitting an RRC connection setup 812 to the second network 806. The UE may also transmit a registration request 814 to the second network. The registration request 814 may comprise a GUTI, as well as mobility registration updating. The registration request 814 may further include an indication of interworking without N14 is supported. The indication of interworking without N14 is supported may inform the AMF associated with the second network that, instead of rejecting the registration request, the GUAMI of the GUTI is related to another AMF (e.g., the AMF associated with the first network) and includes the same MCC+MNC and AMF region ID as the AMF associated with the second network. The MCC+MNC and AMF region ID may be included in a preconfigured list to perform the existing PDU session establishment request procedure. Instead of rejecting the registration request, the second network, at 816, may provide the UE with an identity request, and the UE may respond with a SUPI of the UE.

Authentication and security procedures with the second network may be completed, at 818. For example, the AMF associated with the second network may authenticate the UE 802 on the second network. Upon the completion of the authentication and security procedures with the second network, the AMF associated with the second network may register the UE with the UPF and SMF and the UDM, such that the UE may be deregistered with the AMF associated with the first network. For example, the AMF associated with the second network may inform the UDM that the UE 802 has joined the AMF associated with the second network, such that the AMF associated with the first network is informed that the UE 802 has joined a new AMF and is released from the AMF associated with the first network.

At 820, the UE may provide the second network with an indication of UE capability 820. The UE capability 820 may indicate to the second network that the UE supports an existing PDU session establishment procedure.

At 822, registration procedures with the second network may occur. For example, the second network may provide the UE with a registration acceptance indication, and the UE may respond with a registration complete indication. The registration acceptance indication may comprise an information element of interworking without N14 indication to the UE which may trigger the UE to use handover of PDU session.

At 824, the UE may transmit a PDU session establishment request 824. The PDU session establishment request 824 may comprise a request for an existing PDU session. For example, the UE may request the second network to utilize the existing PDU session that the UE used while on the first network. The AMF associated with the second network may forward the PDU session establishment request to the UPF and SMF to utilize the existing PDU session on the second network. Since the identity of the UE 802 has been previously determined, during at least the authentication and security procedure 818, the existing PDU session request may be granted, such that the UE 802 may utilize the existing PDU session, that the UE utilized on the first network, on the second network. As such, the UE 802 may continue to use the IP address on the second network without interruption to services due to the switch from the first network to the second network.

At 826, the RRC connection procedure may be completed. For example, the second network may provide the UE with an RRC reconfiguration, and the UE may response by transmitting an RRC reconfiguration complete indication.

At 828, the UE 802 is in a connected mode with the second network 806. The UE 802 may communicate with the second network using the existing PDU session.

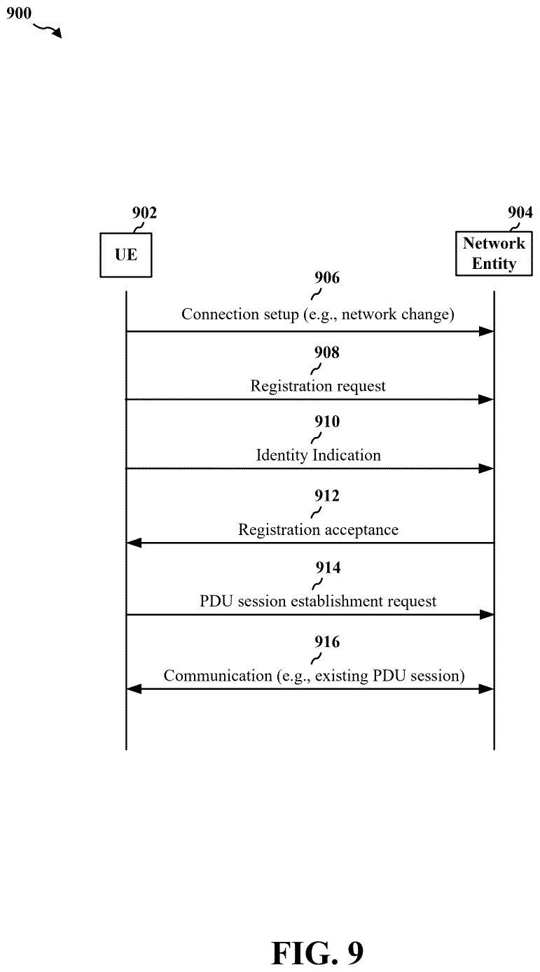

FIG. 9 is a call flow diagram 900 of signaling between a UE 902 and a network entity 904. The network entity 904 may comprise a base station configured to provide at least one cell. The UE 902 may be configured to communicate with the network entity 904. For example, in the context of FIG. 1, the network entity 904 may correspond to base station 102, and UE 902 may correspond to at least UE 104. In another example, in the context of FIG. 3, the network entity 904 may correspond to base station 310 and the UE 902 may correspond to UE 350.

At 906, the UE 902 may initiate a connection setup with a second network. The UE may initiate the connection setup with the second network to initiate a network change from a first network to the second network. The UE may be connected to or communicating with the first network and may initiate the network change to the second network. The network entity 904 may be associated with the second network, where the UE initiates the connection setup with the second network via the network entity 904. The network entity 904 may receive, from the UE 902, a request to initiate the connection setup with the UE 902 to initiate the network change. The connection setup may comprise a radio resource control (RRC) connection setup with the second network. The UE may initiate the connection setup with the second network based on any of the aspects described in connection with FIGS. 6-8.

At 908, the UE 902 may transmit a registration request comprising a mobility registration indication in response to an initiation of the network change. The UE may transmit the registration request to the second network via the network entity 904. For example, the UE may transmit the registration request to the network entity 904 associated with the second network. The network entity 904 may receive the registration request from the UE 902. In some aspects, the mobility registration indication may comprise a GUTI. The GUTI may comprise a mobile country code (MCC), a mobile network code (MNC), an access and mobility management function (AMF) region identifier (ID), an AMF set ID, an AMF pointer, and/or a temporary mobile subscriber identity (TMSI). In some aspects, the GUTI may comprise a global unique AMF ID (GUAMI). Where the GUAMI may be comprised of at least the MCC, the MNC, the AMF region ID, the AMF set ID, and/or the AMF pointer. In some aspects, the registration request may comprise a PDU session establishment indication indicating that the UE supports an existing PDU session establishment procedure. The PDU session establishment indication may comprise at least one of a TAI or an interworking indication. In some aspects, the registration request may comprise an interworking indication indicating support for interworking features. The UE may support an existing PDU session establishment procedure based on the interworking indication indicating support for the interworking features. The UE may transmit the registration request to the second network based on any of the aspects described in connection with FIGS. 6-8.

At 910, the UE 902 may transmit an identity indication in response to an identity request from the second network. The UE 902 may transmit the identity indication to the second network via the network entity 904. The network entity 904 may receive the identity indication from the UE 902. The UE may transmit the identity indication in response to the identity request from the second network in response to the registration request. The network entity 904 may transmit the identity request to the UE 902, in response to the UE 902 transmitting the registration request. The UE may receive, from the second network, the identity request in response to transmitting the registration request. In some aspects, the identity indication may comprise at least one of a subscription permanent identifier (SUPI), a subscription concealed identifier (SUCI), or an international mobile subscriber identity (IMSI). The UE may be authenticated by the second network based on the identity indication. The UE may transmit the identity indication to the second network based on any of the aspects described in connection with FIGS. 6-8.

At 912, the network entity 904 may transmit a registration acceptance indication. The network entity 904 may transmit the registration acceptance indication to the UE 902. The UE 902 may receive the registration acceptance indication from the network entity 904. The network entity may provide the registration acceptance indication in response to transmission of the identity indication from the UE. The network entity may obtain the identity indication from the UE and provide the registration acceptance indication in response to the identity indication from the UE. In some aspects, the registration acceptance indication may comprise an interworking indication indicating that the second network supports an existing PDU session establishment procedure. The network entity may transmit the registration acceptance indication to the UE based on any of the aspects described in connection with FIGS. 6-8.

At 914, the UE 902 may transmit a PDU session establishment request. The UE may transmit the PDU session establishment request to the second network. The UE may transmit the PDU session establishment request indicating an existing PDU session from the first network for use on the second network. The PDU session establishment request may include a request for the existing PDU session from the first network for use on the second network. In some aspects, the PDU session establishment request may be transmitted based on the initiation of the network change. For example, the second network may use a different frequency range than the first network. In such instances, transmission of the PDU session establishment request, by the UE, may be triggered due to the UE utilizing the different frequency range upon the network change to the second network from the first network. In some aspects, the UE may determine that the second network supports establishing the existing PDU session at the second network based on an indication received during authentication of the UE by the second network. The UE may transmit the PDU session establishment request to the second network based on any of the aspects described in connection with FIGS. 6-8.

At 916, the UE 902 may communicate with the second network via the network entity 904. The UE may communicate with the second network using the existing PDU session. The UE may communicate with the second network using the existing PDU session that the UE used while communicating with the first network. The UE using the existing PDU session on the second network allows the UE to maintain settings or parameters without having to update or request a new PDU session when transitioning to the second network. For example, the UE using the existing PDU session on the second network allows the UE to maintain the same IP address such that existing communications are not lost or dropped due to switching to the second network. The UE may communicate with the second network using the existing PDU session based on any of the aspects described in connection with FIGS. 6-8.

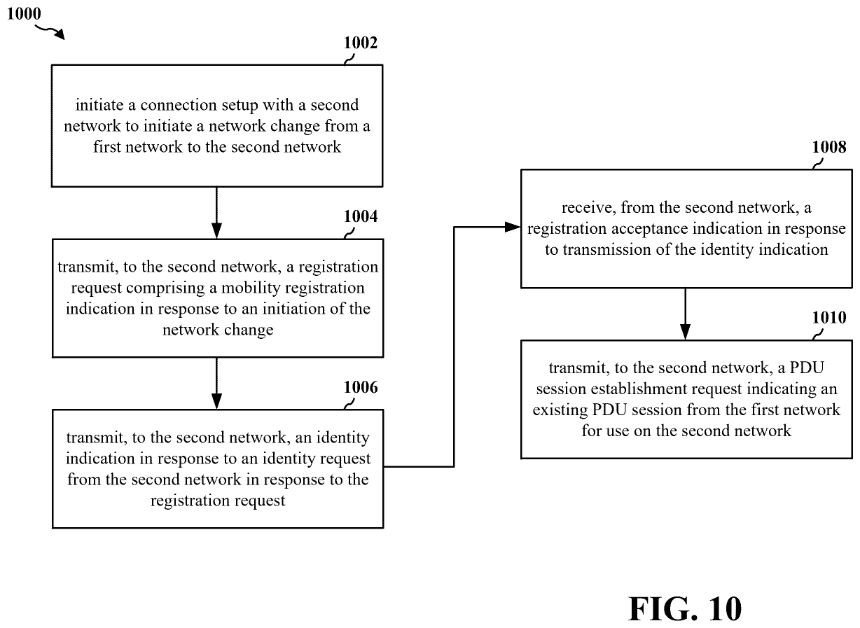

FIG. 10 is a flowchart 1000 of a method of wireless communication. The method may be performed by a UE (e.g., the UE 104; the apparatus 1204). One or more of the illustrated operations may be omitted, transposed, or contemporaneous. The method may allow a UE to utilize an existing PDU session when changing to a different network.

At 1002, the UE may initiate a connection setup with a second network. For example, 1002 may be performed by PDU component 198 of apparatus 1204. The UE may initiate the connection setup with the second network to initiate a network change from a first network to the second network, as shown in connection with any of FIGS. 6-8. The UE may be connected to or communicating with the first network and may initiate the network change to the second network. The connection setup may comprise a RRC connection setup with the second network.

At 1004, the UE may transmit a registration request comprising a mobility registration indication in response to an initiation of the network change, as shown in connection with any of FIGS. 6-8. For example, 1004 may be performed by PDU component 198 of apparatus 1204. The UE may transmit the registration request to the second network. For example, the UE may transmit the registration request to a network entity associated with the second network. In some aspects, the mobility registration indication may comprise a GUTI. The GUTI may comprise a MCC, a MNC, an AMF region ID, an AMF set ID, an AMF pointer, and/or a TMSI. In some aspects, the GUTI may comprise a GUAMI. Where the GUAMI may be comprised of at least the MCC, the MNC, the AMF region ID, the AMF set ID, and/or the AMF pointer. In some aspects, the registration request may comprise a PDU session establishment indication indicating that the UE supports an existing PDU session establishment procedure. The PDU session establishment indication may comprise at least one of a TAI or an interworking indication. In some aspects, the registration request may comprise an interworking indication indicating support for interworking features. The UE may support an existing PDU session establishment procedure based on the interworking indication indicating support for the interworking features.

At 1006, the UE may transmit, to the second network, an identity indication in response to an identity request from the second network. For example, 1006 may be performed by PDU component 198 of apparatus 1204. The UE may transmit the identity indication in response to the identity request from the second network in response to the registration request, as shown in connection with any of FIGS. 6-8. The UE may receive, from the second network, the identity request in response to transmitting the registration request. In some aspects, the identity indication may comprise at least one of a SUPI, a SUCI, or an IMSI. The UE may be authenticated by the second network based on the identity indication.

At 1008, the UE may receive a registration acceptance indication. For example, 1008 may be performed by PDU component 198 of apparatus 1204. The UE may receive the registration acceptance indication from the second network. The UE may receive the registration acceptance indication in response to transmission of the identity indication, as shown in connection with any of FIGS. 6-8. In some aspects, the registration acceptance indication may comprise an interworking indication indicating that the second network supports an existing PDU session establishment procedure.

At 1010, the UE may transmit a PDU session establishment request. For example, 1010 may be performed by PDU component 198 of apparatus 1204. The UE may transmit the PDU session establishment request to the second network. The UE may transmit the PDU session establishment request indicating an existing PDU session from the first network for use on the second network, as shown in connection with any of FIGS. 6-8. The PDU session establishment request may include a request for the existing PDU session from the first network for use on the second network. In some aspects, the PDU session establishment request may be transmitted based on the initiation of the network change. For example, the second network may use a different frequency range than the first network. In such instances, the PDU session establishment request may be triggered due to the UE utilizing the different frequency range upon the network change to the second network from the first network. In some aspects, the UE may determine that the second network supports establishing the existing PDU session at the second network based on an indication received during authentication of the UE by the second network.

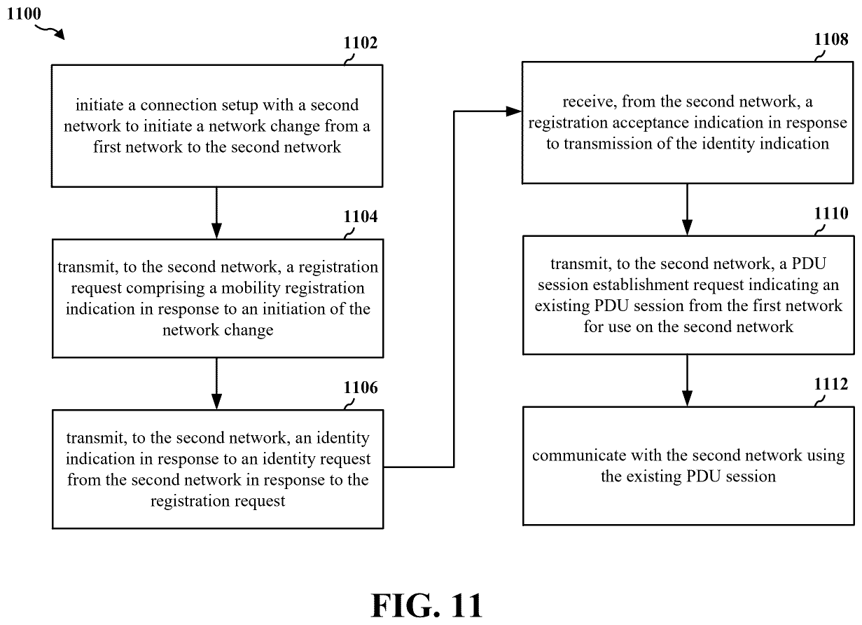

FIG. 11 is a flowchart 1100 of a method of wireless communication. The method may be performed by a UE (e.g., the UE 104; the apparatus 1204). One or more of the illustrated operations may be omitted, transposed, or contemporaneous. The method may allow a UE to utilize an existing PDU session when changing to a different network.

At 1102, the UE may initiate a connection setup with a second network. For example, 1102 may be performed by PDU component 198 of apparatus 1204. The UE may initiate the connection setup with the second network to initiate a network change from a first network to the second network, as shown in connection with any of FIGS. 6-8. The UE may be connected to or communicating with the first network and may initiate the network change to the second network. The connection setup may comprise a radio resource control (RRC) connection setup with the second network.

At 1104, the UE may transmit a registration request comprising a mobility registration indication in response to an initiation of the network change, as shown in connection with any of FIGS. 6-8. For example, 1104 may be performed by PDU component 198 of apparatus 1204. The UE may transmit the registration request to the second network. For example, the UE may transmit the registration request to a network entity associated with the second network. In some aspects, the mobility registration indication may comprise a global unique temporary identifier (GUTI). The GUTI may comprise a mobile country code (MCC), a mobile network code (MNC), an access and mobility management function (AMF) region identifier (ID), an AMF set ID, an AMF pointer, and/or a temporary mobile subscriber identity (TMSI). In some aspects, the GUTI may comprise a global unique AMF ID (GUAMI). Where the GUAMI may be comprised of at least the MCC, the MNC, the AMF region ID, the AMF set ID, and/or the AMF pointer. In some aspects, the registration request may comprise a PDU session establishment indication indicating that the UE supports an existing PDU session establishment procedure. The PDU session establishment indication may comprise at least one of a tracking area identity (TAI) or an interworking indication. In some aspects, the registration request may comprise an interworking indication indicating support for interworking features. The UE may support an existing PDU session establishment procedure based on the interworking indication indicating support for the interworking features.

At 1106, the UE may transmit, to the second network, an identity indication in response to an identity request from the second network. For example, 1106 may be performed by PDU component 198 of apparatus 1204. The UE may transmit the identity indication in response to the identity request from the second network in response to the registration request, as shown in connection with any of FIGS. 6-8. The UE may receive, from the second network, the identity request in response to transmitting the registration request. In some aspects, the identity indication may comprise at least one of a subscription permanent identifier (SUPI), a subscription concealed identifier (SUCI), or an international mobile subscriber identity (IMSI). The UE may be authenticated by the second network based on the identity indication.

At 1108, the UE may receive a registration acceptance indication. For example, 1108 may be performed by PDU component 198 of apparatus 1204. The UE may receive the registration acceptance indication from the second network. The UE may receive the registration acceptance indication in response to transmission of the identity indication, as shown in connection with any of FIGS. 6-8. In some aspects, the registration acceptance indication may comprise an interworking indication indicating that the second network supports an existing PDU session establishment procedure.

At 1110, the UE may transmit a PDU session establishment request. For example, 1110 may be performed by PDU component 198 of apparatus 1204. The UE may transmit the PDU session establishment request to the second network. The UE may transmit the PDU session establishment request indicating an existing PDU session from the first network for use on the second network, as shown in connection with any of FIGS. 6-8. The PDU session establishment request may include a request for the existing PDU session from the first network for use on the second network. In some aspects, the PDU session establishment request may be transmitted based on the initiation of the network change. For example, the second network may use a different frequency range than the first network. In such instances, the PDU session establishment request may be triggered due to the UE utilizing the different frequency range upon the network change to the second network from the first network. In some aspects, the UE may determine that the second network supports establishing the existing PDU session at the second network based on an indication received during authentication of the UE by the second network.

At 1112, the UE may communicate with the second network. For example, 1112 may be performed by PDU component 198 of apparatus 1204. The UE may communicate with the second network using the existing PDU session, as shown in connection with any of FIGS. 6-8. The UE may communicate with the second network using the existing PDU session that the UE used while communicating with the first network. The UE using the existing PDU session on the second network allows the UE to maintain settings or parameters without having to update or request a new PDU session when transitioning to the second network. For example, the UE using the existing PDU session on the second network allows the UE to maintain the same IP address such that existing communications are not lost or dropped due to switching to the second network.

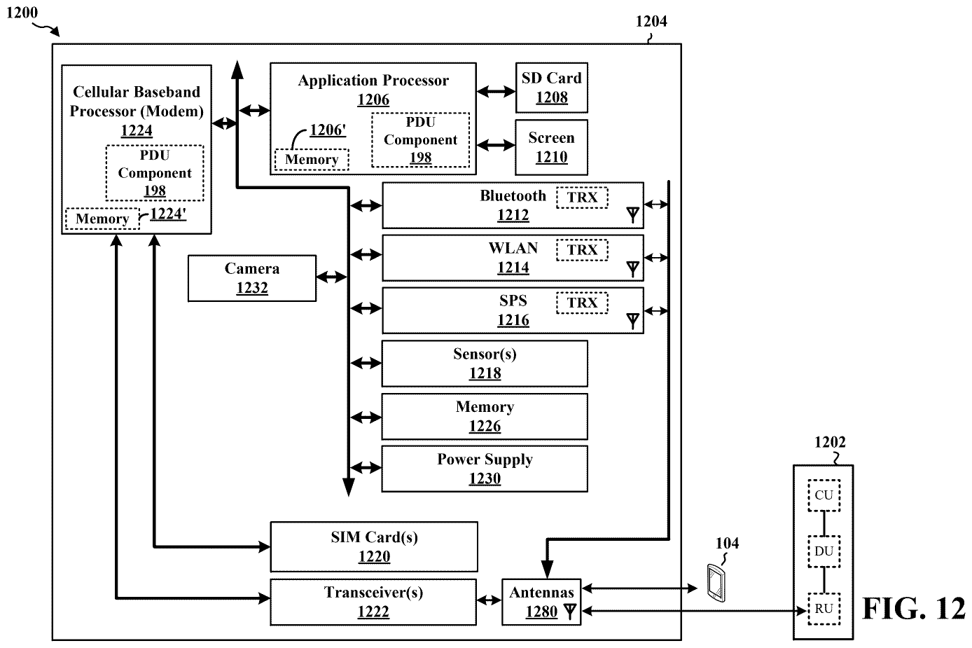

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed supra, the component 198 is configured to initiate a connection setup with a second network to initiate a network change from a first network to the second network; transmit, to the second network, a registration request comprising a mobility registration indication in response to an initiation of the network change; transmit, to the second network, an identity indication in response to an identity request from the second network in response to the registration request; receive, from the second network, a registration acceptance indication in response to transmission of the identity indication; and transmit, to the second network, a PDU session establishment request indicating an existing PDU session from the first network for use on the second network. The component 198 may be within the cellular baseband processor 1224, the application processor 1206, or both the cellular baseband processor 1224 and the application processor 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for initiating a connection setup with a second network to initiate a network change from a first network to the second network. The apparatus includes means for transmitting, to the second network, a registration request comprising a mobility registration indication in response to an initiation of the network change. The apparatus includes means for transmitting, to the second network, an identity indication in response to an identity request from the second network in response to the registration request. The apparatus includes means for receiving, from the second network, a registration acceptance indication in response to transmission of the identity indication. The apparatus includes means for transmitting, to the second network, a PDU session establishment request indicating an existing PDU session from the first network for use on the second network. The apparatus further includes means for communicating with the second network using the existing PDU session. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

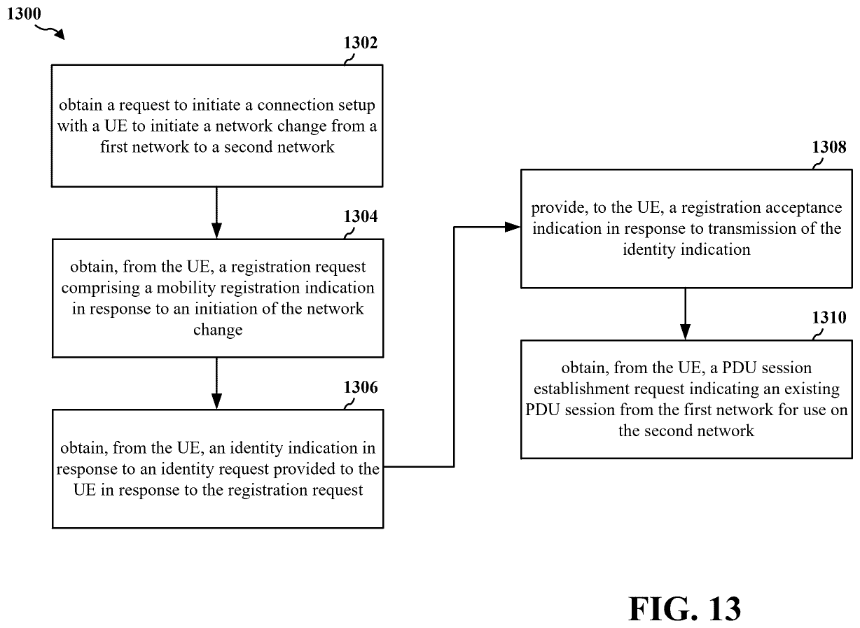

FIG. 13 is a flowchart 1300 of a method of wireless communication. The method may be performed by a network entity (e.g., the base station 102; the network entity 1502. One or more of the illustrated operations may be omitted, transposed, or contemporaneous. The method may allow a UE to utilize an existing PDU session when changing to a different network.

At 1302, the network entity may obtain a request to initiate a connection setup with a UE. For example, 1302 may be performed by connection component 199 of network entity 1502. The network entity may obtain the request to initiate the connection setup with the UE from the UE, as shown in connection with any of FIGS. 6-8. The network entity may obtain the request to initiate the connection setup with the UE to initiate a network change from a first network to a second network. The network entity may be associated with the second network. The request to initiate the connection setup may comprise an RRC connection setup with the network entity associated with the second network.

At 1304, the network entity may obtain a registration request comprising a mobility registration indication in response to an initiation of the network change, as shown in connection with any of FIGS. 6-8. For example, 1304 may be performed by connection component 199 of network entity 1502. The network entity may obtain the registration request from the UE. In some aspects, the mobility registration indication may comprise a GUTI. The GUTI may comprise a MCC, a MNC, an AMF region ID, an AMF set ID, an AMF pointer, and/or a TMSI. In some aspects, the GUTI may comprise a GUAMI, where the GUAMI may be comprised of at least the MCC, the MNC, the AMF region ID, the AMF set ID, and/or the AMF pointer. In some aspects, the registration request may comprise a PDU session establishment indication indicating that the UE supports an existing PDU session establishment procedure. The PDU session establishment indication may comprise at least one of a tracking area identity (TAI) or an interworking indication. In some aspects, the registration request may comprise an interworking indication indicating support for interworking features. The UE may support an existing PDU session establishment procedure based on the interworking indication indicating support for the interworking features.

At 1306, the network entity may obtain, from the UE, an identity indication in response to an identity request provided to the UE. For example, 1306 may be performed by connection component 199 of network entity 1502. The network entity may obtain the identity indication in response to the identity request provided to the UE in response to the registration request, as shown in connection with any of FIGS. 6-8. The network entity may provide the identity request to the UE in response to obtaining the registration request. In some aspects, the identity indication may comprise at least one of a SUPI, a SUCI, or an IMSI. Authentication of the UE, by the second network, may be based on the identity indication.

At 1308, the network entity may provide a registration acceptance indication. For example, 1308 may be performed by connection component 199 of network entity 1502. The network entity may provide the registration acceptance indication to the UE. The network entity may provide the registration acceptance indication in response to transmission of the identity indication from the UE. The network entity may obtain the identity indication from the UE and provide the registration acceptance indication in response to the identity indication from the UE, as shown in connection with any of FIGS. 6-8. In some aspects, the registration acceptance indication may comprise an interworking indication indicating that the second network supports an existing PDU session establishment procedure.

At 1310, the network entity may obtain a PDU session establishment request. For example, 1310 may be performed by connection component 199 of network entity 1502. The network entity may obtain the PDU session establishment request from the UE. The network entity may obtain the PDU session establishment request indicating an existing PDU session from the first network for use on the second network, as shown in connection with any of FIGS. 6-8. The PDU session establishment request may include a request for the existing PDU session from the first network for use on the second network. In some aspects, the PDU session establishment request may be obtained, from the UE, based on the initiation of the network change. For example, the second network may use a different frequency range than the first network. In such instances, transmission of the PDU session establishment request, by the UE, may be triggered due to the UE utilizing the different frequency range upon the network change to the second network from the first network. In some aspects, the second network may support establishing the existing PDU session based on an indication provided to the UE during authentication of the UE by the second network. For example, the indication provided to the UE during authentication may indicate whether the second network supports establishing the existing PDU session.

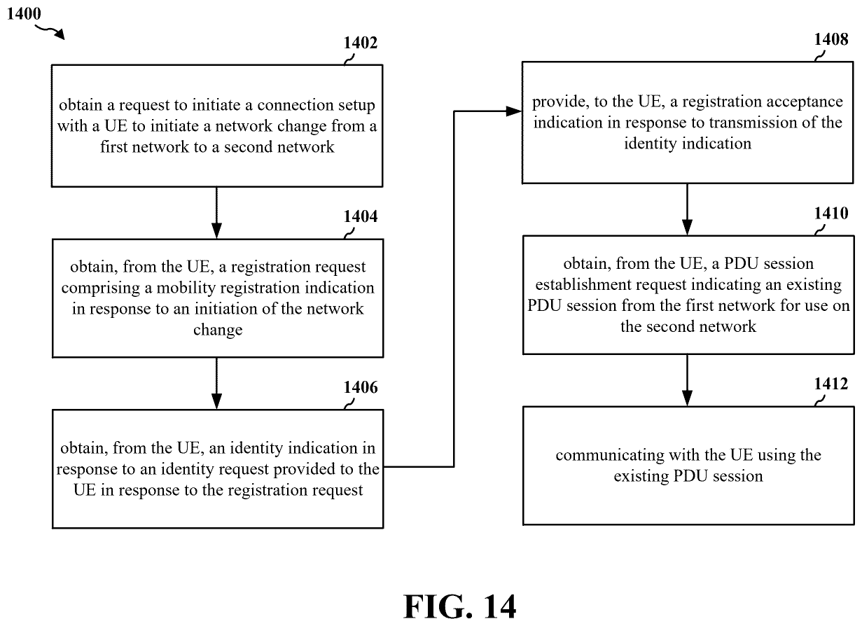

FIG. 14 is a flowchart 1400 of a method of wireless communication. The method may be performed by a base station (e.g., the base station 102; the network entity 1502. One or more of the illustrated operations may be omitted, transposed, or contemporaneous. The method may allow a UE to utilize an existing PDU session when changing to a different network.

At 1402, the network entity may obtain a request to initiate a connection setup with a UE. For example, 1402 may be performed by connection component 199 of network entity 1502. The network entity may obtain the request to initiate the connection setup with the UE from the UE, as shown in connection with any of FIGS. 6-8. The network entity may obtain the request to initiate the connection setup with the UE to initiate a network change from a first network to a second network. The network entity may be associated with the second network. The request to initiate the connection setup may comprise an RRC connection setup with the network entity associated with the second network.

At 1404, the network entity may obtain a registration request comprising a mobility registration indication in response to an initiation of the network change, as shown in connection with any of FIGS. 6-8. For example, 1404 may be performed by connection component 199 of network entity 1502. The network entity may obtain the registration request from the UE. In some aspects, the mobility registration indication may comprise a GUTI. The GUTI may comprise a MCC, a MNC, an AMF region ID, an AMF set ID, an AMF pointer, and/or a TMSI. In some aspects, the GUTI may comprise a GUAMI, where the GUAMI may be comprised of at least the MCC, the MNC, the AMF region ID, the AMF set ID, and/or the AMF pointer. In some aspects, the registration request may comprise a PDU session establishment indication indicating that the UE supports an existing PDU session establishment procedure. The PDU session establishment indication may comprise at least one of a tracking area identity (TAI) or an interworking indication. In some aspects, the registration request may comprise an interworking indication indicating support for interworking features. The UE may support an existing PDU session establishment procedure based on the interworking indication indicating support for the interworking features.

At 1406, the network entity may obtain, from the UE, an identity indication in response to an identity request provided to the UE. For example, 1406 may be performed by connection component 199 of network entity 1502. The network entity may obtain the identity indication in response to the identity request provided to the UE in response to the registration request, as shown in connection with any of FIGS. 6-8. The network entity may provide the identity request to the UE in response to obtaining the registration request. In some aspects, the identity indication may comprise at least one of a SUPI, a SUCI, or an IMSI. Authentication of the UE, by the second network, may be based on the identity indication.

At 1408, the network entity may provide a registration acceptance indication. For example, 1408 may be performed by connection component 199 of network entity 1502. The network entity may provide the registration acceptance indication to the UE. The network entity may provide the registration acceptance indication in response to transmission of the identity indication from the UE. The network entity may obtain the identity indication from the UE and provide the registration acceptance indication in response to the identity indication from the UE, as shown in connection with any of FIGS. 6-8. In some aspects, the registration acceptance indication may comprise an interworking indication indicating that the second network supports an existing PDU session establishment procedure.

At 1410, the network entity may obtain a PDU session establishment request. For example, 1410 may be performed by connection component 199 of network entity 1502. The network entity may obtain the PDU session establishment request from the UE. The network entity may obtain the PDU session establishment request indicating an existing PDU session from the first network for use on the second network, as shown in connection with any of FIGS. 6-8. The PDU session establishment request may include a request for the existing PDU session from the first network for use on the second network. In some aspects, the PDU session establishment request may be obtained, from the UE, based on the initiation of the network change. For example, the second network may use a different frequency range than the first network. In such instances, transmission of the PDU session establishment request, by the UE, may be triggered due to the UE utilizing the different frequency range upon the network change to the second network from the first network. In some aspects, the second network may support establishing the existing PDU session based on an indication provided to the UE during authentication of the UE by the second network. For example, the indication provided to the UE during authentication may indicate whether the second network supports establishing the existing PDU session.

At 1412, the network entity may communicate with the UE. For example, 1412 may be performed by connection component 199 of network entity 1502. The network entity, associated with the second network, may communicate with the UE using the existing PDU session, as shown in connection with any of FIGS. 6-8. The network entity may communicate with the UE using the existing PDU session that the UE used while communicating with the first network. The network entity communicating with the UE using the existing PDU session on the second network allows the UE to maintain settings or parameters without having to update or request a new PDU session when transitioning to the second network. For example, the UE using the existing PDU session on the second network allows the UE to maintain the same IP address such that existing communications are not lost or dropped due to switching to the second network.

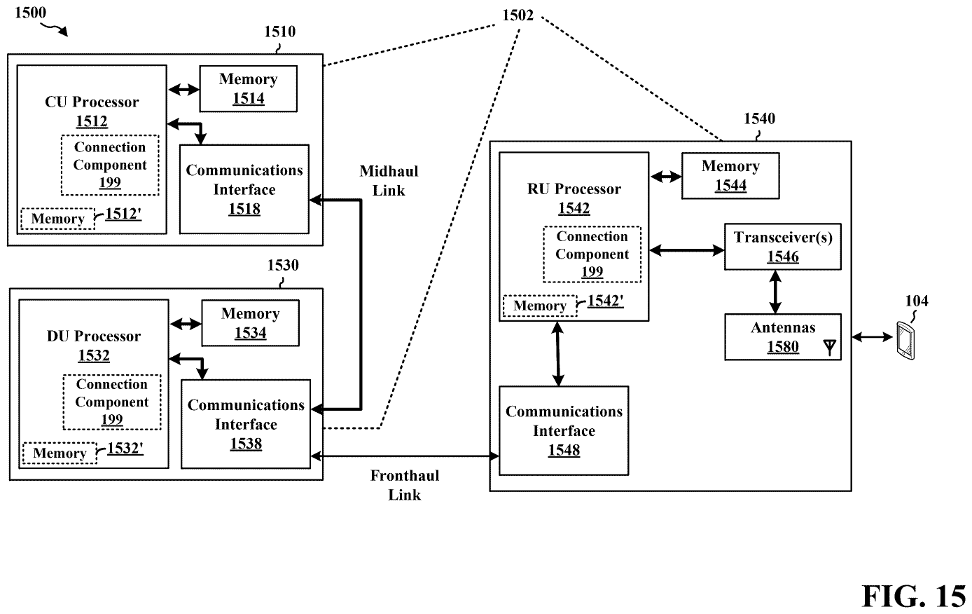

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include a CU processor 1512. The CU processor 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include a DU processor 1532. The DU processor 1532 may include on-chip memory 1532′. In some aspects, the DU 1530 may further include additional memory modules 1534 and a communications interface 1538. The DU 1530 communicates with the RU 1540 through a fronthaul link. The RU 1540 may include an RU processor 1542. The RU processor 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to obtain a request to initiate a connection setup with a UE to initiate a network change from a first network to a second network, wherein the network entity is associated with the second network; obtain, from the UE, a registration request comprising a mobility registration indication in response to an initiation of the network change; obtain, from the UE, an identity indication in response to an identity request provided to the UE in response to the registration request; provide, to the UE, a registration acceptance indication in response to transmission of the identity indication; and obtain, from the UE, a PDU session establishment request indicating an existing PDU session from the first network for use on the second network. The component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1502 may include a variety of components configured for various functions. In one configuration, the network entity 1502 includes means for obtaining a request to initiate a connection setup with a UE to initiate a network change from a first network to a second network. The network entity is associated with the second network. The network entity includes means for obtaining, from the UE, a registration request comprising a mobility registration indication in response to an initiation of the network change. The network entity includes means for obtaining, from the UE, an identity indication in response to an identity request provided to the UE in response to the registration request. The network entity includes means for providing, to the UE, a registration acceptance indication in response to transmission of the identity indication. The network entity includes means for obtaining, from the UE, a PDU session establishment request indicating an existing PDU session from the first network for use on the second network. The network entity further includes means for communicating with the UE using the existing PDU session. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

Various aspects relate generally to optimization of inter-AMF mobility. Some aspects more specifically relate to a configuration to allow for inter-AMF interface to be supported in instances where hardware from different vendors is used for at least the AMF between different networks. In some examples, a UE may provide identification information related to the UE to allow an existing PDU session, utilized on an existing network, to be established on a new network. For example, a UE may be connected to a first network and may initiate a network change to a second network, such that the existing PDU session from the first network may be utilized by the UE on the second network. At least one advantage of the disclosure is that a UE switching from a first network to a second network may utilize an existing PDU session, utilized on the first network, on the second network upon switching onto the second network.

Using the existing PDU session on the second, or newly connected network, may allow the UE to maintain services that utilized the existing PDU session and not experience any service interruptions. In another example, the UE may provide a GUTI to the second or new network. An advantage of providing the GUTI to the new network is that the new network, instead of rejecting the registration request, may utilize the GUTI to verify the identity of the UE. In yet another example, the registration request may comprise an interworking indication indicating support for interworking features. The support for interworking features may indicate to the new network that the UE supports an existing PDU session establishment procedure.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising initiating a connection setup with a second network to initiate a network change from a first network to the second network; transmitting, to the second network, a registration request comprising a mobility registration indication in response to an initiation of the network change; transmitting, to the second network, an identity indication in response to an identity request from the second network in response to the registration request; receiving, from the second network, a registration acceptance indication in response to transmission of the identity indication; and transmitting, to the second network, a PDU session establishment request indicating an existing PDU session from the first network for use on the second network.

Aspect 2 is the method of aspect 1, further includes that the connection setup comprises a RRC connection setup with the second network.

Aspect 3 is the method of any of aspects 1 and 2, further includes that the mobility registration indication comprises a GUTI.

Aspect 4 is the method of any of aspects 1-3, further includes that the GUTI comprises a MCC, a MNC, an AMF region ID, an AMF set ID, an AMF pointer, and a TMSI, wherein the GUTI comprises a GUAMI, wherein the GUAMI is comprised of at least the MCC, the MNC, the AMF region ID, the AMF set ID, and the AMF pointer.

Aspect 5 is the method of any of aspects 1-4, further includes that the identity indication comprises at least one of a SUPI, SUCI, or an IMSI.

Aspect 6 is the method of any of aspects 1-5, further includes that the UE is authenticated by the second network based on the identity indication.

Aspect 7 is the method of any of aspects 1-6, further includes that the PDU session establishment request is transmitted based on the initiation of the network change, wherein the second network uses a different frequency range than the first network, wherein the PDU session establishment request is triggered due to utilizing the different frequency range upon the network change to the second network.

Aspect 8 is the method of any of aspects 1-7, further including determining that the second network supports establishing the existing PDU session at the second network based on an indication received during authentication of the UE by the second network.

Aspect 9 is the method of any of aspects 1-8, further includes that the registration request comprises a PDU session establishment indication indicating that the UE supports an existing PDU session establishment procedure, wherein the PDU session establishment indication comprises at least one of a TAI or an interworking indication.

Aspect 10 is the method of any of aspects 1-9, further including communicating with the second network using the existing PDU session.

Aspect 11 is the method of any of aspects 1-10, further includes that the registration request comprises an interworking indication indicating support for interworking features, wherein the UE supports an existing PDU session establishment procedure based on the interworking indication indicating support for the interworking features.

Aspect 12 is the method of any of aspects 1-11, further includes that the registration acceptance indication comprises an interworking indication indicating that the second network supports an existing PDU session establishment procedure.

Aspect 13 is an apparatus for wireless communication at a UE including at least one processor coupled to a memory and at least one transceiver, the at least one processor configured to implement any of aspects 1-12.

Aspect 14 is an apparatus for wireless communication at a UE including means for implementing any of aspects 1-12.

Aspect 15 is a computer-readable medium storing computer executable code, where the code when executed by a processor causes the processor to implement any of aspects 1-12.

Aspect 16 is a method of wireless communication at a network entity, comprising obtaining a request to initiate a connection setup with a UE to initiate a network change from a first network to a second network, wherein the network entity is associated with the second network; obtaining, from the UE, a registration request comprising a mobility registration indication in response to an initiation of the network change; obtaining, from the UE, an identity indication in response to an identity request provided to the UE in response to the registration request; providing, to the UE, a registration acceptance indication in response to transmission of the identity indication; and obtaining, from the UE, a PDU session establishment request indicating an existing PDU session from the first network for use on the second network.

Aspect 17 is the method of aspect 16, further includes that the request to initiate the connection setup comprises a RRC connection setup with the network entity associated with the second network.

Aspect 18 is the method of any of aspects 16 and 17, further includes that the mobility registration indication comprises a GUTI.

Aspect 19 is the method of any of aspects 16-18, further includes that the GUTI comprises a MCC, a MNC, an AMF region ID, an AMF set ID, an AMF pointer, and a TMSI, wherein the GUTI comprises a GUAMI, wherein the GUAMI is comprised of at least the MCC, the MNC, the AMF region ID, the AMF set ID, and the AMF pointer.

Aspect 20 is the method of any of aspects 16-19, further includes that the identity indication comprises at least one of a SUPI, a SUCI, or an IMSI.

Aspect 21 is the method of any of aspects 16-20, further includes that authentication of the UE is based on the identity indication.

Aspect 22 is the method of any of aspects 16-21, further includes that the PDU session establishment request is obtained based on the initiation of the network change, wherein the PDU session establishment request is obtained based on a different frequency range utilized on the second network than a frequency ranged utilized on the first network.

Aspect 23 is the method of any of aspects 16-22, further includes that the second network supports establishing the existing PDU session based on an indication provided to the UE during authentication of the UE by the second network.

Aspect 24 is the method of any of aspects 16-23, further includes that the registration request comprises a PDU session establishment indication indicating that the UE supports an existing PDU session establishment procedure, wherein the PDU session establishment indication comprises at least one of a TAI or an interworking indication.

Aspect 25 is the method of any of aspects 16-24, further including communicating with the UE using the existing PDU session.

Aspect 26 is the method of any of aspects 16-25, further includes that the registration request comprises an interworking indication indicating support for interworking features, wherein the UE supports an existing PDU session establishment procedure based on the interworking indication indicating support for the interworking features.

Aspect 27 is the method of any of aspects 16-26, further includes that the registration acceptance indication comprises an interworking indication indicating that the second network supports an existing PDU session establishment procedure.

Aspect 28 is an apparatus for wireless communication at a network entity including at least one processor coupled to a memory and at least one transceiver, the at least one processor configured to implement any of Aspects 16-27.

Aspect 29 is an apparatus for wireless communication at a network entity including means for implementing any of Aspects 16-27.

Aspect 30 is a computer-readable medium storing computer executable code, where the code when executed by a processor causes the processor to implement any of Aspects 16-27.

1. An apparatus for wireless communication at a user equipment (UE), comprising: a memory; and
at least one processor coupled to the memory and, based at least in part on information stored in the memory, the at least one processor is configured to:
initiate a connection setup with a second network to initiate a network change from a first network to the second network;
transmit, to the second network, a registration request comprising a mobility registration indication in response to an initiation of the network change;
transmit, to the second network, an identity indication in response to an identity request from the second network in response to the registration request;
receive, from the second network, a registration acceptance indication in response to transmission of the identity indication; and
transmit, to the second network, a packet data unit (PDU) session establishment request indicating an existing PDU session from the first network for use on the second network.

2. The apparatus of claim 1, further comprising a transceiver coupled to the at least one processor.

3. The apparatus of claim 1, wherein the connection setup comprises a radio resource control (RRC) connection setup with the second network.

4. The apparatus of claim 1, wherein the mobility registration indication comprises a global unique temporary identifier (GUTI).

5. The apparatus of claim 4, wherein the GUTI comprises a mobile country code (MCC), a mobile network code (MNC), an access and mobility management function (AMF) region identifier (ID), an AMF set ID, an AMF pointer, and a temporary mobile subscriber identity (TMSI), wherein the GUTI comprises a global unique AMF ID (GUAMI),
wherein the GUAMI is comprised of at least the MCC, the MNC, the AMF region ID, the AMF set ID, and the AMF pointer.

6. The apparatus of claim 1, wherein the identity indication comprises at least one of a subscription permanent identifier (SUP I), subscription concealed identifier (SUCI), or an international mobile subscriber identity (IMSI).

7. The apparatus of claim 1, wherein the UE is authenticated by the second network based on the identity indication.

8. The apparatus of claim 1, wherein the PDU session establishment request is transmitted based on the initiation of the network change, wherein the second network uses a different frequency range than the first network, wherein the PDU session establishment request is triggered due to utilizing the different frequency range upon the network change to the second network.

9. The apparatus of claim 1, wherein the at least one processor is configured to determine that the second network supports establishing the existing PDU session at the second network based on an indication received during authentication of the UE by the second network.

10. The apparatus of claim 1, wherein the registration request comprises a PDU session establishment indication indicating that the UE supports an existing PDU session establishment procedure, wherein the PDU session establishment indication comprises at least one of a tracking area identity (TAI) or an interworking indication.

11. The apparatus of claim 1, wherein the at least one processor is configured to:
communicate with the second network using the existing PDU session.

12. The apparatus of claim 1, wherein the registration request comprises an interworking indication indicating support for interworking features, wherein the UE supports an existing PDU session establishment procedure based on the interworking indication indicating support for the interworking features.

13. The apparatus of claim 1, wherein the registration acceptance indication comprises an interworking indication indicating that the second network supports an existing PDU session establishment procedure.

14. A method of wireless communication at a user equipment (UE), comprising:
initiating a connection setup with a second network to initiate a network change from a first network to the second network;
transmitting, to the second network, a registration request comprising a mobility registration indication in response to an initiation of the network change;
transmitting, to the second network, an identity indication in response to an identity request from the second network in response to the registration request;
receiving, from the second network, a registration acceptance indication in response to transmission of the identity indication; and
transmitting, to the second network, a packet data unit (PDU) session establishment request indicating an existing PDU session from the first network for use on the second network.

15. The method of claim 14, further comprising:
communicating with the second network using the existing PDU session.

16. An apparatus for wireless communication at a network entity, comprising:
a memory; and
at least one processor coupled to the memory and, based at least in part on information stored in the memory, the at least one processor is configured to:
obtain a request to initiate a connection setup with a user equipment (UE) to initiate a network change from a first network to a second network, wherein the network entity is associated with the second network;
obtain, from the UE, a registration request comprising a mobility registration indication in response to an initiation of the network change;
obtain, from the UE, an identity indication in response to an identity request provided to the UE in response to the registration request;
provide, to the UE, a registration acceptance indication in response to transmission of the identity indication; and
obtain, from the UE, a packet data unit (PDU) session establishment request indicating an existing PDU session from the first network for use on the second network.

17.-22. (canceled)

23. The apparatus of claim 16, wherein the PDU session establishment request is obtained based on the initiation of the network change, wherein the PDU session establishment request is obtained based on a different frequency range utilized on the second network than a frequency ranged utilized on the first network.

24. The apparatus of claim 16, wherein the second network supports establishing the existing PDU session based on an indication provided to the UE during authentication of the UE by the second network.

25. The apparatus of claim 16, wherein the registration request comprises a PDU session establishment indication indicating that the UE supports an existing PDU session establishment procedure, wherein the PDU session establishment indication comprises at least one of a tracking area identity (TAI) or an interworking indication.

26. The apparatus of claim 16, wherein the at least one processor is configured to:
communicate with the UE using the existing PDU session.

27.-30. (canceled)
